(19) United States
(12) Patent Application Publication
(10) Pub. No.: US 2013/0013477 A1
(43) Pub. Date: Jan. 10, 2013

(54) SYSTEM AND METHOD OF EXCHANGING FINANCIAL SERVICES INFORMATION AND OF COMMUNICATION BETWEEN CUSTOMERS AND PROVIDERS

(76) Inventor: Carlos ORTEGA, Chicago, IL (US)

(21) Appl. No.: 13/179,551

(22) Filed: Jul. 10, 2011

(51) Int. Cl. G06Q 40/00

(52) U.S. Cl. 705/35

(57) ABSTRACT

One embodiment of the invention is a financial services information service that allows financial service customers to securely post their financial needs and to impart instructions pertaining to suppliers of financial services reviewing said needs. Intending to identify new transactions and acquire new customers, financial service providers review needs posted by costumers in the customer database. Providers select the entries of interest and can purchase the legal names of customers associated with specific needs. Business method intends fee charges to be attractive to providers of financial services in view of typical customer acquisition costs and to promote selectivity and to avoid abuses by providers. For additional fees providers can also send high customized messages to potential customers in order to maximize attractiveness of initial contact. Invention also creates a ratings and review method intended to differentiate providers and reward financial services providers worldwide committed to excellent service. Customers remain empowered during the process by selecting and excluding providers accessing information about their posted needs and ultimately deciding which providers will obtain their contact information. The system provides a method for the customers and providers to communicate and for third parties to advertise.

### BACKGROUND OF THE INVENTION

1. Field of the Invention

The invention relates to exchanging information between potential customers and service providers, specifically in this embodiment a system of exchanging announcements of needs for financial services from potential customers and of expressions to serve those needs and information by providers of financial services, which may result in these parties engaging in active communication.

2. Background of the Invention

Most organizations around the world, perhaps with the exception of large corporations and companies with access to capital markets, don't have the ability to search for optimum possible financial terms available to them for their funding needs and all other financial and non-financial products they use. Time constraints, limited number of or unsophisticated personnel and a small number of banking and financial services relationships are among the reasons why many organizations simply cannot access the best deals available to them in the market.

As a result, entities may end up paying higher financial costs and accepting more restricting conditions than necessary. In turn, higher financial costs increase a firm's cost of capital and limited sources of financing constrain a firm's growth, reducing flexibility and may even lead to financial distress and default.

Given lack of sophistication and limited banking and financial services relationships, customers may also not be aware of existence of the most suitable products for them. Rather, customers may generally know about the kind of need they have, but not the proper solution to the need. In order to pursue research, time, energy and resources are diverted from a company's core business and long term competitiveness.

Similarly, individuals who have limited time may be paying higher costs and being subject to more restrictive terms than necessary. While some individuals are willing to invest a significant amount of time researching, not all individuals are willing or able to do so. A reduced number of banking and financial services relationships constrains flexibility and can even lead to bankruptcy for individuals.

Suppliers of financial services, such as banks derive profits from the provision of financial services and auxiliary services. For example, banks profit from issuing traditional loans, reselling pre-existing loan obligations on the secondary loan markets, and through the provision of non-loan services. Non-loan services may include services such as bill payment, payroll, accounting, and financial advice.

While the current customers of an entity providing financial services are a key asset, there is only so many services that pre-existing customers require and are willing to consume. Therefore, in order to continuously increase opportunities for new profit, financial institutions are obligated to actively identify new transactions and have a regular influx of new customers, both individuals and legal entities, such as corporations or individual units within larger corporations.

Most banks and other providers of financial services have a limited capacity to identify potential customers and needs available to them. Banks are constrained by their own resources in terms of physical branch/offices presence across the United States and abroad, numbers of established relationships, network of contacts, sales personnel and marketing budget. The largest banks hold material advantages against smaller competitors in terms of resources providing domestic and international presence and procuring market intelligence.

In order to grow their business, financial institutions invest domestically and internationally to create physical presence through building branches, opening offices and hiring bankers. Banks also sign correspondent and representative agreements, and spend heavily in research and marketing. All the aforementioned are components driving customer acquisition costs for banks.

In order to identify business opportunities and obtain new customers, financial institutions currently undertake investments in physical presence and traditional marketing efforts, including mass mailings, special promotions for opening accounts, and the like. Many financial institutions spend considerable amounts on advertising and the analytics needed before any advertising campaign is finalized and approved. For example, costly demographic analysis is often required before a mass mailing indicating “pre-approval” for a loan product can be sent to potential new customers.

Financial institutions undertake similar efforts when creating electronic marketing messages. First, extensive demographic studies are performed, and these are followed by tailoring marketing messages and offers to the profiles of potential new customers.

The reliance on demographic information suffers from several inherent problems. First, such information can only indicate that a given party is likely to be interested in the suggested product, and not that the party is actually in need of the product. Second, mass marketing efforts are costly, and again reach parties who are not seeking new services, but rather happen to have a particular demographic profile. Third, use of demographic information for mass marketing is subject to an ever-increasing regulatory pressure, with more and more customers being resentful of unsolicited offers. Even if the marketing is highly targeted, it is likely that same would not be timely or that it will be ignored by potential customers due to the fatigue amongst both individuals and corporations stemming from large quantities of unrequested marketing information.

Many suppliers of financial services also seek new transactions and customers by drawing new customers to physical locations, for example local bank branches. However, even a modest local bank branch could cost hundreds of thousands of dollars to open. For a small or medium-sized financial institution, entering a new region could be cost-prohibitive, if in order to build a local client base it would have to build even a couple physical bank branches.

Some of these costs associated with acquiring new customers are addressed by moving a portion of the financial institution's process online. For example, a financial institution may participate in a service where it can compete for new customers who are looking for a particular type of loan. These services suffer from considerable drawbacks, however, in that they require customers to be matched with pre-existing offers in the matching database. When participating, the financial institutions identify the profile of a new client they are willing to accept, the financial institution is allowed to automatically pre-approve such applicants in the system, offering them the opportunity to apply for a loan. However, such services are inherently limited in that they require a matching of a potential new customer to a pre-existing participating institution. Customers with non-traditional needs or needs not anticipated by the system are unable to participate. As such, by using matching services, financial institutions are limited to only a small subset of potential new customers.

The problems associated with obtaining new customers are exacerbated during times of economic contraction when customers look for ways to deleverage. However, if customers are made aware of highly competitive offers, the customers may be willing to pursue financing for business or personal investment.

Potential customers having a financial services need often do not have the time necessary to establish relationships with multiple financial institutions. Currently, pre-existing relationships with only a few financial suppliers are relied upon to obtain new loans or other financial services. The result is that often, the customer ends paying higher costs and being subject to more restrictive terms than could be secured if the customer had knowledge of a competing financial institution. Given the value of new customers and the large number of financial institutions both nationally within the US and worldwide, customers need a resource-effective means to communicate needs to financial service companies.

Presently, customers who need a new financial service can obtain competing quotes from multiple institutions by completing the time-intensive process of filing multiple applications, either with individual financial services companies or with multiple aggregate matching services. An individual or a corporation having responsibilities other than securing financial instruments will rely on pre-existing relationships rather than incur the time and expense of filing such multiple applications.

A need exists in the art for a means for providers of financial services to compete for new transactions and to search for new customers without incurring high costs. A need exists in the art for a means for customers to communicate their financial services needs with providers of financial services, without having to invest time and resources providing extensive information to be matched with a particular lender.

The system as described herein provides several benefits to parties involved in the system.

During any period of economic constriction, but especially with the “The Great Recession”, the focus of a large number of companies and individuals in the U.S. and worldwide has been on de-leveraging (or reducing the amount of debt in their balance sheets). As a result, bank balance sheets in the U.S. have continued to shrink as customers repay loan commitments and as the demand for additional debt remains subdued. Weaker than expected economic growth and reduced appetite for more debt in the developed world have created the perception that most banks lack the capacity to grow their loan portfolios and substantial discounts are being applied by equity markets to bank valuations.

The discounts applied to most bank stocks in equity markets are also taking into consideration expected increases in minimum capital requirements for most banks around the world. More demanding capital requirements will further constrain most financial institution's ability to build commercial infrastructure and may further inhibit bank's ability to extend credit and grow loan portfolios.

The current environment further exacerbates the competitive disparities among banks. Larger financial institutions, for the most part, are much better equipped to withstand the economic and regulatory headwinds. Smaller banks have now less chance of succeeding or even surviving as independent entities.

Given the much slower economic growth in developed economies, banks in developed countries are increasingly facing the need to expand into third world economies. Most banks don't have the necessary resources to pursue such internationally expansion.

At a macro level higher cost of debt due to market imperfections increase the cost of capital. A higher cost of capital eliminates investment opportunities which otherwise may appear attractive. Reduced incentives to invest constrain employment, economic growth and quality of life worldwide.

The time, energy and resources devoted by organizations to search for funding and other financial products distract management away from the crucial focus on improving own business and enhancing i competitiveness. The time, energy and resources devoted by individuals also create a diversion from more productive activities. On a macro level, ultimately a country's long-term competitive position will suffer as well.

Resources currently devoted by service providers to strengthen their geographic coverage and marketing budgets to identify and chase new deals consume substantial economic capital, time and talent. A service allowing financial service providers to identify and engage new business opportunities on a worldwide basis on a highly targeted, timely and economic basis can valuably assist in the reallocation of resources into key long-term priorities such as product innovation, strengthening of capital position, risk management or simply returned to shareholders to be reassigned somewhere else in the economy

### SUMMARY OF INVENTION

An object of the invention is to provide a system for providers of financial services to identify new transactions and discover new clients. A feature of the invention is a means for potential customers worldwide to post their needs for financial services to providers of financial services around the world and for providers of financial services to review and to respond to such needs. An advantage of the invention is that it intends to drastically reduce the customer acquisition costs banks and other suppliers of financial services incur in order to identify and establish business relationships with individuals and legal entities around the world.

Another object of the invention is to allow potential customers to successfully attract various and perhaps many providers of financial services wanting to compete in order to satisfy their financial needs. A feature of the invention is that any qualifying participating provider of financial services in the world may express interest to discuss a customers' financial need located anywhere in the world. An advantage of the invention is that provides dramatically increased visibility to borrowers and clients of financial services globally. Increased visibility is conducive to obtaining best financial terms available. Effortless visibility frees up time and energy previously devoted to the search and purchase of financial services.

Another object of the invention is to facilitate interactions between customers and suppliers of financial needs around existing and specific business opportunities. A feature of the invention is that the basic activating event for a supplier to want to connect with a customer through this service is the announcement of an existing need by a customer. Advantages of the invention are the enablement of highly relevant business interactions and an improvement in the way scarce resources such as personnel, time and money are deployed.

Another object of the invention is to allow potential customers to establish new relationships with providers of financial services. A feature of the invention is that any qualifying participating supplier of financial services may express interest in establishing communication with a potential customer. An advantage of the invention is that it gathers information about business opportunities which may have not been obtained by providers of financial services in the absence of this invention.

A further object of the invention is to allow providers of financial services without a pre-existing physical presence to compete for potential new customers. A feature of the invention is the provision of a service for potential customers to exchange information with providers of financial services previously-unknown to the potential customers. An advantage of the invention is that provides a high effective channel for financial services worldwide to become known by potential customers.

An additional object of the invention is to promote worldwide visibility around providers of financial services providing truly outstanding service and generating high customer satisfaction. A feature of the invention is for ratings and reviews to become differentiating factors between providers. An advantage of the invention is that creates a competitive advantage to providers devoted to excellent service but without the financial resources necessary to generate strong brand awareness through investments in marketing and an extensive physical presence.

An object of the invention is to allow banks and other suppliers of financial services anywhere in the world to compete anywhere in the world for business where they are legally authorized to operate. A feature of the invention is that providers of financial services, including ones foreign to the potential customers' region, may identify the particular financial needs in a given region. An advantage of the system is that providers of financial services will be able to enter a new region through competing to satisfy a particular financial need in that new region. A further advantage is to help suppliers of financial services in developed markets to take advantage of growth in developing markets.

An object of the present invention is to provide suppliers of financial services meaningful savings in term of investments in local presence (branches), hiring personnel to call and visit companies worldwide, marketing (e.g. direct mailing, massive advertising) and save all the analytics to identify customers. An advantage of the system is that it reduces the entry barriers for new suppliers in terms of cost to service new customer segments, product types and regions.

An object of the present invention is to provide a means of exchanging information with as little overhead as possible. A feature of the invention is that neither the potential new customer nor the provider of financial services must fill out extended applications to participate in the system. An advantage of the present invention is that the amount of time needed to begin participation in the system is low. A further objective of the system is to provide information to financial institutions with varying costs by the banks. A feature of the system is that it can assign different fee values to different information about new customers. An advantage of the system is that it can assign fees for financial institutions based on objective worth criterion.

Another object of the invention is to allow providers of financial services to seek new transactions and customers without first identifying qualifying criteria. A feature of the invention is that eligible providers of financial services are not simply matched with new customers who meet pre-established criterion. Rather, a feature of the invention is that a qualifying provider of financial services may review any financial need within the system. An advantage of the invention is that participating providers can choose not to have to set pre-existing profiles for new transactions and customers. This feature procures new market intelligence and opportunities providers may not be aware of across regions, types of products and client segments.

Another object of the invention is to reduce customer acquisition costs for providers of financial services while fostering discipline around providers' interactions with customers. A feature of the invention is that information identifying customers associated with financial needs is sold to providers. An advantage of the system is that it generates savings for suppliers of financial services, in consideration of typical acquisition costs, while also promoting selectivity and protection of customers' privacy. An additional objective of the invention is to provide a highly effective channel for suppliers of financial services worldwide to become known by potential customers. A feature of the invention is that given knowledge of the need of a potential new customer, provider may send to the potential new customer highly targeted, timely and relevant information. A further feature of the invention is that many different types of media, such as audio and video may be used to overcome an inherent hesitation of customers to begin a financial relationship with an unfamiliar entity. An advantage of the invention is that an unknown provider of financial services has the opportunity to maximize its initial impact and attractiveness on a potential new customer.

Yet another object of the invention is to provide customers savings in time and energy building relationships with banks and surveying the market for sources of funds and services. Another object of the invention is to enable gains for customers in terms of visibility, speed and flexibility. A feature of the invention is that once a need is posted customers can opt to just wait for expressions of interest from suppliers to be delivered to them. This passive role frees up customer's resources. An advantage of the system is that it empowers customers to spend more time on more productive activities including operating their core business and to access the truly best financial costs and terms available to them.

Yet another object of the invention is to provide customers with control over the information provided to the system. Features of the invention are that the potential customer may direct the system to not disclose a financial need to certain providers of financial services and that contact information of customer is not released to a supplier without a customer's authorization. An advantage of the system is that the system enjoys additional trust from potential customers of financial services. An additional objective is to create for potential customers a means to build trust around unfamiliar providers of financial services. A feature of the invention is that potential customers can access customer satisfaction ratings and reviews written on providers of financial services. An advantage of the invention is that potential customers may be more willing to accept establishing communication with unfamiliar providers of financial services based on evidence of a positive record with other clients.

A further objective of the system is to provide an information exchange which is financially self-sufficient. A feature of the system is that providers of financial services pay fees to initiate communication with potential new customers. An advantage of the system is that fees charged are attractive to providers of financial services in consideration of typical customer acquisition costs while at the same time representing a barrier for financial providers to indiscriminately engage customers therefore promoting selectivity.

In one embodiment, the invention comprises an information service for customers comprising: a system presenting an opportunity for customers to save resources in selecting a provider to fulfill a customer need, said system having a means for customers to provide to the system information about said customers, said information comprising a need and instructions; wherein said need is posted to the system without all information about the posting customer visible within the system; a means for registered providers to save resources in identifying business opportunities in viewing said needs; a means for providers to select a need in the system and to pay for identification information about the customer who posted a selected need; and a means for the providers to transmit to customers one or more messages regarding services of the providers; wherein the providers pay a fee for sending said messages; a means for the customers to protect their privacy and selectively engage the providers when the providers select a customer's need and attempts to contact the customer; wherein said system allows the customers to increase market visibility of their needs and wherein said system is conducive to allow the customers to obtain the lowest costs and best terms available to meet said needs; wherein service enables the providers to compete and also to differentiate themselves through ratings and reviews.

In another embodiment, the invention comprises an information service comprising: a customer registration means for customers to register with the service and prescreening information provided by the customers; a service provider registration means for financial service providers to register with the service and prescreening information provided by the providers; a customer posting means for at least one registered customer to post information about a financial need of said registered customer, said financial need including one or more objective criterion, and the need including one or more instructions; a provider registration and review means for at least one registered provider to review all qualifying financial needs posted in the system filtering the needs on the basis of objective criterion included in each of the qualifying posted financial needs; a market intelligence means where a provider can review and be informed about financial needs and can purchase customer identifying information associated with certain financial needs; communication and advertising means wherein an interested provider selects at least one identified customer associated with the posted financial need to initiate discussion of financial need and can opt to deliver marketing information and contact information of the selected customer is disclosed to the interested provider only at the discretion of customer wherein said one or more instructions associated with a need may indicate that a customer prevents one or more providers from reviewing the customer's need.

### BRIEF DESCRIPTION OF DRAWINGS

The invention together with the above and other objects and advantages will be best understood from the following detailed description of the preferred embodiment of the invention shown in the accompanying drawings, wherein:

FIG. 1 is an overview of one embodiment of the invention;

FIG. 2 is a flow chart showing the process of a customer interacting with the system pursuant to one embodiment of the invention;

FIG. 3 is another flow chart showing the process of a customer interacting with the system pursuant to one embodiment of the invention;

FIG. 4 is a flow chart showing the process of a provider interacting with the system pursuant to one embodiment of the invention;

FIG. 5 is another flow chart showing the process of a provider interacting with the system pursuant to one embodiment of the invention;

FIG. 6 is a flow chart of communications between parties in the system pursuant to one embodiment of the invention;

FIG. 7 is a flow chart of communications between parties in the system pursuant to one embodiment of the invention; and

FIG. 8 is a flow chart of ratings entered between the parties in the system pursuant to pursuant to one embodiment of the invention.

### DETAILED DESCRIPTION OF THE INVENTION

The foregoing summary, as well as the following detailed description of certain embodiments of the present invention, will be better understood when read in conjunction with the appended drawings.

To the extent that the figures illustrate diagrams of the functional blocks of various embodiments, the functional blocks are not necessarily indicative of the division between hardware circuitry. Thus, for example, one or more of the functional blocks (e.g. processors or memories) may be implemented in a single piece of hardware (e.g. a general purpose signal processor or a block of random access memory, hard disk or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and preceded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

As used herein, a “customer” is any kind of an entity, including by not limited to individuals, partnerships, limited liability corporations, incorporated entities both public and private, government bodies, and subunits of any of these groups, such as departments within larger corporate units, and subsidiaries.

The term “provider” is likewise any kind of an entity, including an individual, a bank, a brokerage, or any other entity capable of providing a financial product or service designed to address a “financial need” described below.

While the two participants in the system are described as “customers” and “providers,” in one embodiment of the system, a user of the system may act as both a customer and a provider. For example, in one embodiment, a provider of financial services, also requires financial services in a different geographical area, therefore it acts as a “customer” in the system as well as its primary role of “provider.”

The terms “need” as used herein designate any service, product or transaction sought by a potential customer or a provider, including loans, but not limited to acquiring new debt. For instance, a “financial need” may reflect a refinancing of existing obligations, purchasing of services such as cash management, trade products, placement of debt and equity in financial markets, asset sales, and the like. The “financial need” may also encompass other fields related to finance, such as a customer seeking an insurance product or commodities trading and procurement. In other embodiments, a “need” may include a requirement to acquire non-financial resources, such as a customer requiring commodities.

As used herein, a “mechanism” is a means for a user (either a customer or a provider) to interact with the system. A “mechanism” may be implemented using a computer interface element, such as a webpage available on a networked computer system or systems. In some embodiments, the system is represented by a single application running on a multi-purpose computer used by the users of the system, and in this embodiment, the various “mechanisms” are system interface elements, such as text input boxes, menu items, command buttons, text labels, checkboxes, and the like. In another embodiment, the system is implemented using a server-client model, wherein portions of the system, the logic and data stores described below, are stored on the server. Users interact with the server component by accessing client systems, these client systems being implemented as applications, web pages, or a mix of both. Changes to the system data stores performed by users invoking “mechanisms” and reflected in the data stores, are verified by the central server. In another embodiment, the central server is implemented using multiple interconnected systems operating on multi-purpose computers.

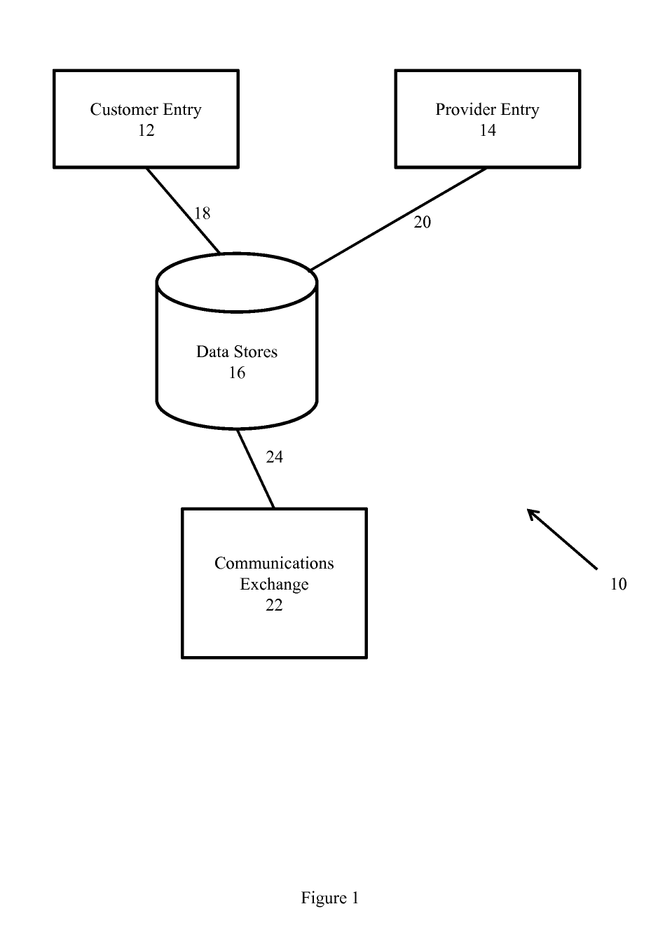

Turning to the figures, a top-level overview of one embodiment of the services information system 10 is found in FIG. 1. The information system 10 comprises several overall elements, a customer entry subsystem 12, a provider entry subsystem 14. The customer entry subsystem 12 and the provider subsystem 14 are the principal interfaces to the information system 10 in the embodiment depicted in FIG. 1.

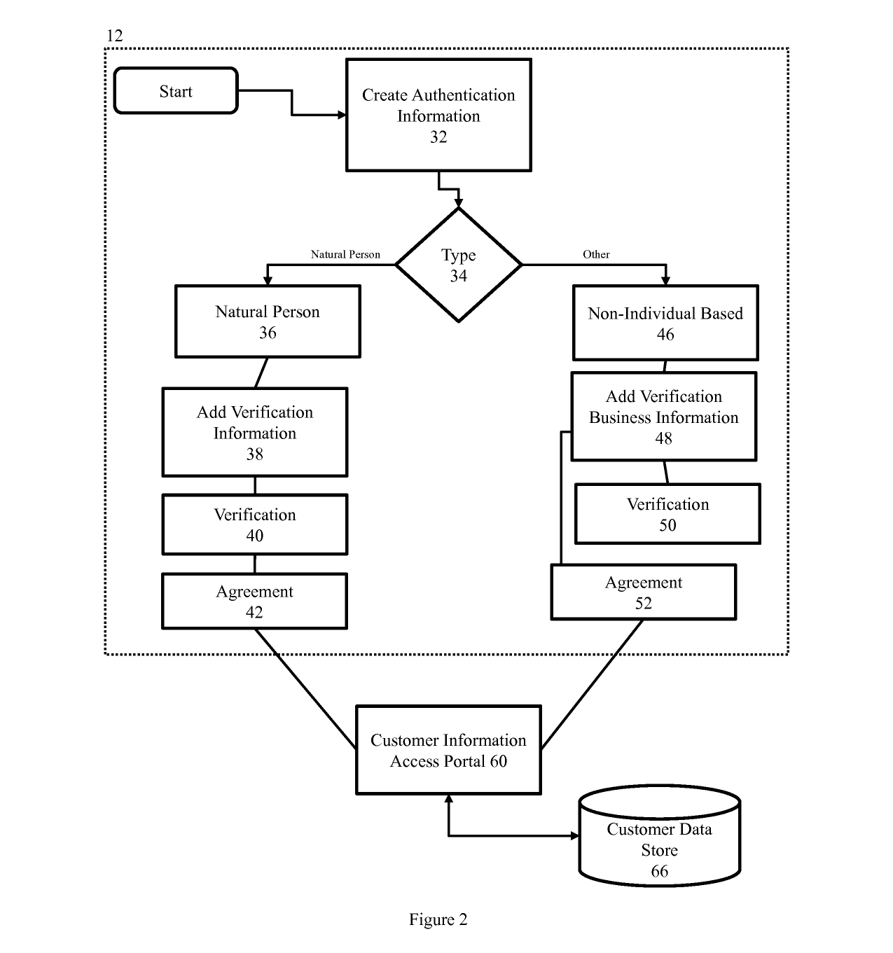

The customer subsystem 12 facilitates the authentication of customers into the information system 10. Customers wishing to be authorized to use the information system 10 are required to register with the information system 10. The process of registration and authorization into the system is described in conjunction with FIG. 2 below.

Upon successful authorization into the system, the customer has access to the Customer Entry subsystem 12. As will be described subsequently, the customer may use the subsystem to evaluate communications from providers, and otherwise perform read and write operations to the one or more central data stores 16. The read and write operations are performed securely by the customer access channel 18.

The system also includes a provision for providers to access the central data stores 16 by authorizing with the provider entry subsystem 14. Much as the information for customers is verified in the customer subsystem 12, the uniquely identifiable information of providers is verified in the provider entry subsystem 14. The full details of the provider verification system are found below given that the system 10 is designed to accommodate many different types of providers.

While the customers use the customer entry subsystem 12 to add and remove entries to the central data store 16 using the secure communications channel 18, providers use their own communications channel 20 to access the information in the central data store 16. Upon finding at least one entry in the central data store 16 of interest to the provider authenticated through the provider subsystem 14, the provider accesses certain details of that selected entry.

The selection of an entry in the central data store 16 moves the interaction to the communications exchange 22 by transferring the relevant information to the information exchange 22 via the needs database connection 24. The communications exchange 22 queries the central data store 16 to obtain the identity of the customer 12 associated with the selected records. The customer entry subsystem 12 is used to notify the relevant customer that a provider wishes to inquire about the customer's need. If the customer responds to the inquiry through the entry subsystem 12 reciprocating a provider's interest to discuss need, the customer and provider use the communications exchange 22 to establish communication. Further negotiations and discussion about how a provider can meet the requirements of customer in order to fulfill need are expected to take place outside of this system once contact information of customer has been released.

Any one financial need posted by a customer or a provider in the central data store 16 may result in multiple providers making inquiries. While in one embodiment, the central data store 16 comprises several computer databases it's understood that any number of data stores may be used to gather customers' and providers' needs within the information system 10, both computerized and ones not dependent on a computer-based implementation.

### Customer Authentication and Registration

The customer authentication system is depicted in detail in FIG. 2. In the embodiment shown in FIG. 2, the authentication of customers occurs within the customer entry subsystem 12; however, in other embodiments this process does not occur within a separate subsystem.

In the embodiment shown in FIG. 2, registration with the entry subsystem 12 is required. Initial registration occurs at a publicly-accessible website. In one embodiment, any potential client is required to ensure compliance with relevant regulation prior to signing up with the system. In another embodiment, the system ensures that customers have complied with pre-registration requirements given that customers from certain regions are required to have a prior clearance before being allowed to register. Said pre-clearance is obtained by the potential new registrant following a selection procedure. For example, in some jurisdictions, the relevant regulation may require pre-screening before a customer may obtain financing by outside entities. Pre-screening to the system would be issued only once the customer has complied with the relevant financial disclosure regulation.

If a given customer is duly authorized to register, the registration process begins with the user creating the authentication information 32 necessary to return and access the system during subsequent visits.

The process begins with a customer creating authentication information 32. In one embodiment this authentication information comprises a username and password pairing. In other embodiments, this authentication information 32 comprises additional authentication means, such as providing an electronic certificate issued by a third party along with a unique username and password. In other embodiments, following the creation of the authentication information 32, the customer must also associate the account with a secondary authentication device, such as the output of a biometric reader (such as that of a fingerprint) or a physical token device. This additional authentication information is associated with that particular customer account.

Upon creation of the authentication information, as part of the type determination 34, the customer is asked to provide an indication whether or not the customer is an entity whose legal identity is based on a natural person or individual. For example, some authentication information will be associated with individuals, or entities whose legal definition is dependent on individuals (such as an entry for a family). Further, in some jurisdictions, legal entities that have a separate legal definition may nonetheless be primarily based on the natural persons comprising the legal entity. An example of such a legal entity is a partnership—while having a separate identity in some respects, a partnership's liabilities remain intertwined with the natural persons comprising the partnership. Therefore, the type determination 34 must take into account the relevant local business unit types and distinguish between customers based on individuals 36, and customers having a completely separate legal persona 50.

In regards to customers who are either natural persons or are directly based on natural persons 36, the registration process continues by asking the customer to provide verification information 38. This information 38 is used to ensure that the individual person is not fictional, therefore giving the providers participating in the information exchange system 10 some assurance that information will result in viable customers. The information necessary for verification 38 includes, but is not restricted to, the customer's legal name, a unique national identification number, demographic information, and contact information. Depending on the jurisdiction, additional information may be required, such as the customer's primary region of residence. In many jurisdictions, different financial regulations apply depending on the regional affiliation of the customer, and this information is needed to verify both the customer's identity but also to verify the customer's ability to participate in the system.

Once the individual 36 customer completes their verification information 38 provision step, the information is provided to the necessary verification authority. In FIG. 2, the verification process 40 is depicted as a separate step from the data provision step 38. However, in some embodiments, these two steps may occur simultaneously, or nearly in real time by for example, verifying every information component provided by the customer in step 38 as the information is being completed. Furthermore, while in FIG. 2, the two steps are shown as occurring in a consecutive order, in other embodiments, these steps are iterative, especially if any part of the verification step 40 fails. In an iterative embodiment, the customer is allowed to re-enter any information which could not be successfully verified.

Presuming that the verification step 40 is successful, the customer is asked to agree to the terms of use of the system 42. The terms of use are designed to shift liability from the information exchange system to the customer, especially to the extent the system exists to allow customers to create content such as profiles and needs. While the system is designed to comply with relevant laws and regulations, the system must require consumers to remain responsible for their own actions. The agreement step 42 is designed to remind customers of that aspect of the business. In other embodiments of the system, the customer agreement 42 is presented to the user even before the verification step 40 is concluded. In such embodiments, the information gathering step 38 and the agreement step 42 are joined together.

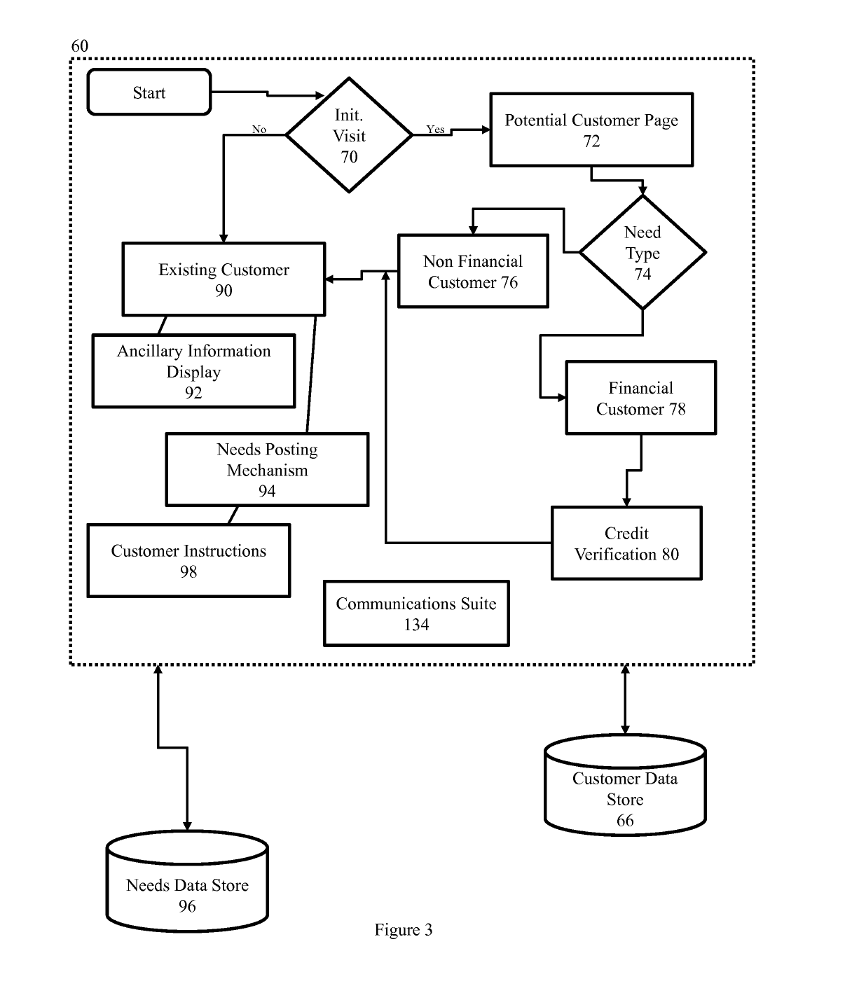

Once the customer agrees to the terms of use of the system 42, the registration process is completed and the new customer information access portal is created for the customer. Interaction with the system following access to the Customer Information Access Portal 60 is described in conjunction with FIG. 3 below.

The registration and verification process 46 is different for new customers which are not based on natural persons. Such new customers include private and public companies, limited liability corporations, municipalities, and other entities whose legal persona exists separately from any one natural person.

The registration process for such entities begins with the provision of confidential business information 48 needed to verify the new customer into the system 10. Much as was the case for individuals, one purpose of this confidential information is to ensure that the new customer is a bona fide participant in the system. For non-natural persons, the verification information 48 required, would include but is not restricted to the legal name of the entity, the principal location or locations of the entity, the relevant industry in which the entity operates, and the number of employees. Depending on the industry to which the entity belongs, follow up information may be required at the information provision step 48. For example, if the entity is in a manufacturing-based industry, the new customer may be required to provide information about facility certifications, hazardous materials licenses, and the like. As part of the business verification step, the new customer must also provide contact information and select a person or designated team of persons to interact with the system. Finally, to assist in the valuation of the new customer, the business information step 48 requests that the new customer provide some overview objective measurements of the entity, such as gross revenues, sales, or profit numbers, and also contact information including point person in a position to discuss a financial need.

Upon the completion of the data input step 48, the new customer's information is verified 50; much in the same way that the individual new customer's information 38 is also verified 40. Several of the components of the information step 48 may be verified by third parties and using publicly available information sources and are completed by the system 10 internally. However, pursuant to the terms of service of the system 10, the information in the system is not guaranteed to be independently verified and audited, in one embodiment. Given that in one embodiment, the system 10 does not require new customers to pay a registration fee, it is important that the new customer agree to the terms of service prior to the system incurring the cost of verification 50. Therefore, the agreement acceptance step 52 occurs before the verification step 40 is completed.

As was the case for customers who are natural persons, the verification step 50 of non-natural persons involves an iterative process should any of the information provided 48 be flagged as suspect. However, upon the successful verification 50 and acceptance of the relevant terms of use of the system 52, the non-natural person based new customer gains access to the Customer Access Information Portal 60. Each customer, whether the customer is a natural person or a non-natural person gains access to an information portal assigned to that particular customer and accessible only following successful authentication 32 into the customer entry subsystem 12.

The Customer Information Access Portal 60 interacts with the Customer Data Store 66, one of the data stores 16 of the system 10 depicted in FIG. 1.

Customer Interaction with System

The Customer Information Access Portal 60 operation details are described in conjunction with FIG. 3. In one embodiment, the Customer Information Access Portal 60 operates in at least two modes—one mode for a “Potential Customer” where the Portal 60 contains information for new customers to the system, and a different mode of operation for established customers.

As such, the Customer Information Access Portal 60 begins with determining whether the authenticated customer interacting with the Customer Information Access Portal 60 is returning to the system from prior visits. In one embodiment, the Portal 60 automatically determines whether the session is the customer's first visit to the system. In another embodiment, the customer is asked whether this is a first visit to the system. In yet another embodiment the initial visit determination 70 occurs automatically, but the customer is able to manually override the system's determination 70.

In one embodiment, the initial visit 70 determination takes into consideration the amount of time that has expired since the customer's last interaction with the Access Portal 60. In one embodiment, if the customer has not authenticated into the system in a period of 120 days (a fiscal quarter) or has not interacted with the system during a similar time period, the customer will be treated as a new customer by the initial visit 70 determination. In one embodiment, this “reset by expiration” determination cannot be overridden because the data associated with the expired customer has been removed from the Customer Data Store 66 pursuant to a data retention policy explained to the user in the agreement step 42, 52 of the initial registration procedure detailed in FIG. 2.

In one embodiment, customers who are new to the system are provided with a “Potential Customer Page” 72. The purpose of this page is to remind the customer of the operation of the system. As a new customer, the customer is given an opportunity to describe the need that the customer will be posting to the system. The Portal 60 allows the customers to characterize the type of the need. If needed, the type or category of the need is also partially ascertained by the system by asking the customer questions or providing a menu comprising different options. Ascertaining the type 74 or category of the need is important to ensure efficient routing of same. In one embodiment, the needs of the customers are divided into several categories based on the initial entry of the customer. For example, certain customers will require consulting services, marketing analysis services, and similar non-financial services 76. However, for some customers seeking a financial need 78 entailing credit risk, the initial process requires a credit check 80.

The credit verification step 80 occurs only once in a set period of time per customer which could be 180 days and once it is determined that the customer's credit score is directly relevant to the customer's attractiveness to providers of financial instruments. Customers are not excluded from the system 10 based on the results of the credit score 80 nor are customers matched with the financial services providers based on the credit score 80 results. Nonetheless, the credit verification 80 results, including a credit score, are stored in the Customer Data Store 66. For those customers not seeking a financial need entailing credit risk, the credit check 80 step is unnecessary. However, in one embodiment, the customer is able to opt-in to participate in a credit verification so that should the customer provide a financial need in the future, the ability to post the financial need is not delayed by first obtaining the credit profile of the customer as part of the verification step 80.

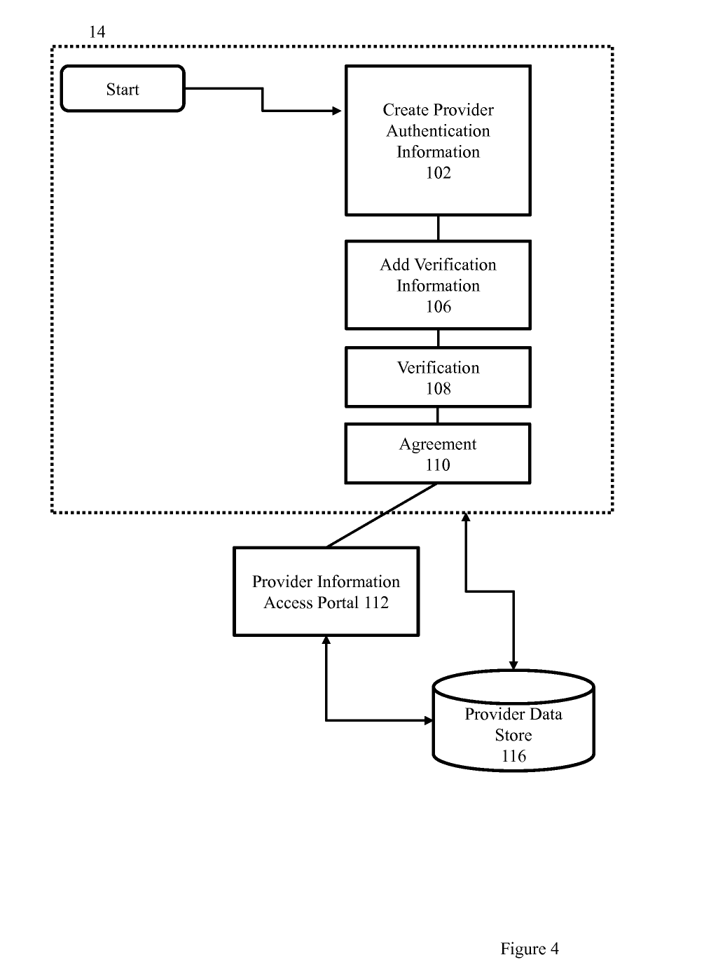

Customers who have already previously visited the system as determined by the initial visit determination 70 interact with the system 10 using the Existing Customer Interface 90. In one embodiment, once the type of the first-time customer is determined, the first time customers are also directed to this Existing Customer Interface 90. The Existing Customer Interface 90 comprises a Needs Posting Mechanism 92 and Ancillary Information Display 92. The Ancillary Information Display is discussed below in conjunction with FIG. 4.

The posting of a financial need begins with the Need Posting Mechanism 94. In one embodiment, for new customers, who initially categorized their need at step 74, the Need Posting Mechanism 94 is pre-populated with information previously provided by the customer. The Need Posting Mechanism begins with the customer providing details about the financial need. The information about the need is included in the Need Data Store 96 and associated with the customer's entry in the Customer Data Store 66. In one embodiment, the Needs Posting Mechanism 94 allows the customer to provide instructions regarding the need, whether that need is financial or not. For example, the Customer Instructions 98 may include a list of providers that the Customer would like to be target of the need. For example, the customer may have a particular provider that the customer wishes to engage, but lacks the complete contact information of the provider to be able to contact the provider directly. In one embodiment, such instructions are stored in the Needs Data Store 96 and translate to that particular need being a directed need in that it is directed to at least one specific provider. In another embodiment, the Customer Instructions facility 98 allows for customers to identify a type or class of provider that should be targeted with the need. Furthermore, in another embodiment, the Customer Instruction Facility 98 allows the customer to select providers which the Customer does not wish to work with, and wants the need to be excluded from. The Customer Instructions Facility 98 ensures that the customer remains empowered as to what happens to the need once it is posted to the Customer Information Portal 60.

Beyond providing a means for initially posting customer needs, the Posting Mechanism 94 allows customers to perform maintenance tasks related to the need. For example, the Needs Posting Mechanism 94 allows a customer to remove the need from the Portal 60 by explicitly cancelling the need. A cancellation could occur if the customer's need is fulfilled, if the need becomes irrelevant to the customer, or if the need expires. The Needs Posting Mechanism automatically updates the Needs Data Store 96 to reflect changes initiated by the customer or by the system 10.

In one embodiment, every need added to the system would have to be reviewed and “refreshed” by the customer to prevent automatic expiration of the need every set period, such as 120 days.

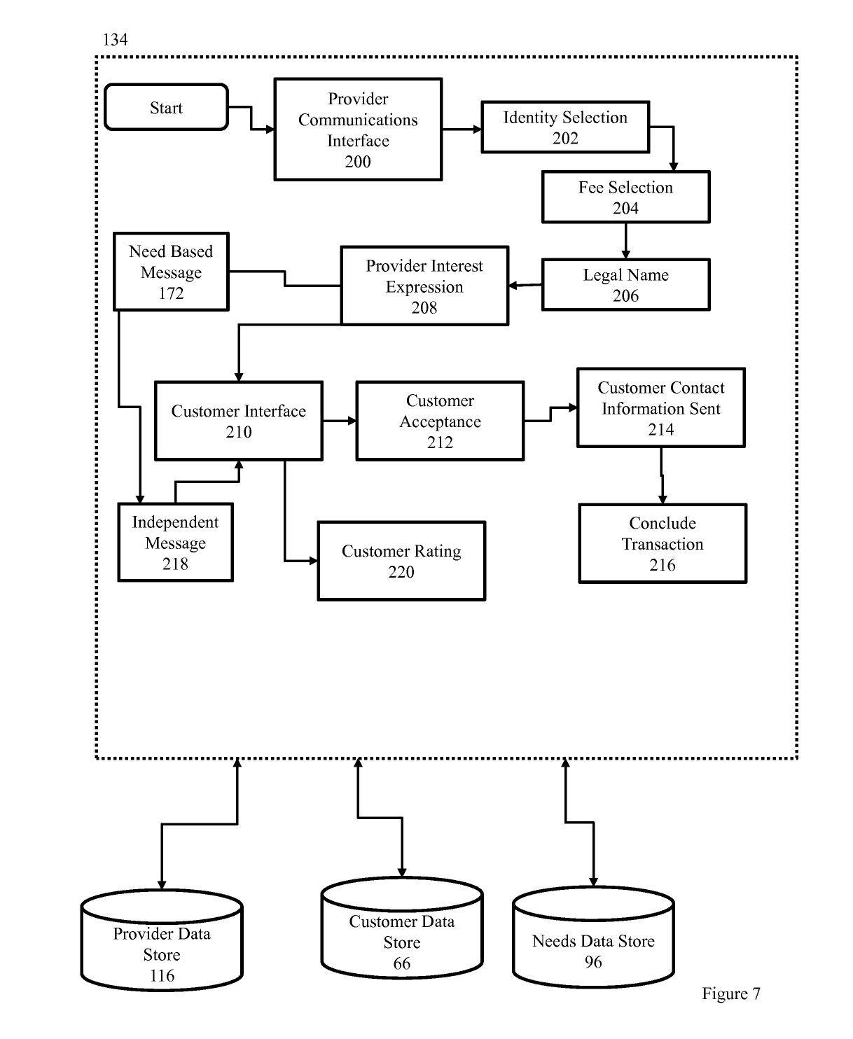

In order to communicate with providers, the Customer Information Portal 60 also includes a mechanism to access the Communications Suite 134, the details of which are discussed below in conjunction with FIG. 7.

Certain details of customer needs posted to the system using the Needs Posting Mechanism 94 are reviewed by providers, the details of which are discussed below.

### Provider Authentication and Registration

Inasmuch as providers in the system will have access to non-public information about the customers, providers must likewise be authenticated into the system. The process of authenticating providers is described in FIG. 4.

As depicted in FIG. 4, the authentication and registration of providers occurs within the provider entry subsystem 14. While the authentication systems for providers 14 and customers 12 are shown as separate subsystems, in one embodiment of the invention, the authentication and registration tasks are handled by the same software logic components. However, in other embodiments, the provider and customer information is kept separate from one another, in order to raise the security profile of the system.

Further, while the two entry systems 12 and 14 are shown as separate systems, the actual parties that interact with the system 10 are not limited to only one role as either a customer or a provider. For example, the system allows a single party to have access to both the Provider Information Access Portal 112 and the Customer Information Access Portal 60, given that for some transactions a member may act as a provider of a service, and another transaction the same member may act as a customer.

Much like customers are required to create authentication information in step 32, providers are required to create unique identification information in step 102. For providers, the responsibility for maintaining the account as secure is higher given that providers can incur fees and exclusion from use or abuse of the system, which is detailed below. Therefore, there would be additional impetus for providers to use sophisticated authentication procedures, beyond simple username and password pairs.

Following the creation of the authentication information 102, each provider needs to enter into the system verification information 106. The verification information required varies depending on the type of provider seeking an account. In one embodiment of the invention, minimal verification of the provider occurs, with only the contact information being verified to be correct. In other embodiments, varying amounts of verification take place. For example, a well-established financial institution may need only information showing that the person seeking the account is authorized to act on behalf of the financial institution. For entities with unknown reputations, the verification information 106 provided at this step can be more thorough and may include details such as the length of time spent in business, the number of customers, and so forth. At the minimum, every provider would have to indicate their legal name, the type of service the provider wishes to sell through the system 10 and general information, such as address of physical locations. Finally, every provider must also designate a contact person and provide contact information during the verification information phase 106.

Once enough of the information is gathered, the provider information 106 is verified 108 using a mix of private and public methods as described in customer verification steps 40, 50. As was the case with the verification 40, 50 of customer information, should any issues arise, the provider verification step 108 would ask the potential new provider to correct the information in the previous step 106. Therefore the information provision step 106 and verification step 108 are not completely distinct nor are they strictly sequential.

In one embodiment, following verification 108 of the information 106, the potential new provider is asked to acquiesce to the provider terms of service by signing an agreement 110. In another embodiment, the provider is asked to execute the relevant terms of service agreement 110 at the same time as the provider adds the verification information 106.

In any event, following acceptance of the terms of use 110, the provider gains access to the Provider Information Access Portal 112. The operation of the Provider Information Access Portal 112 is described fully below.

During the registration process, the data entered by the provider is being committed to a Provider Data Store 116. In one embodiment, the Provider Data Store 116 acts as a master list of all providers of services within the information system. Changes to the Provider Information Portal 112 are also stored in the Provider Data Store 116, as will be discussed further below.

Provider Interactions with Customer Entries

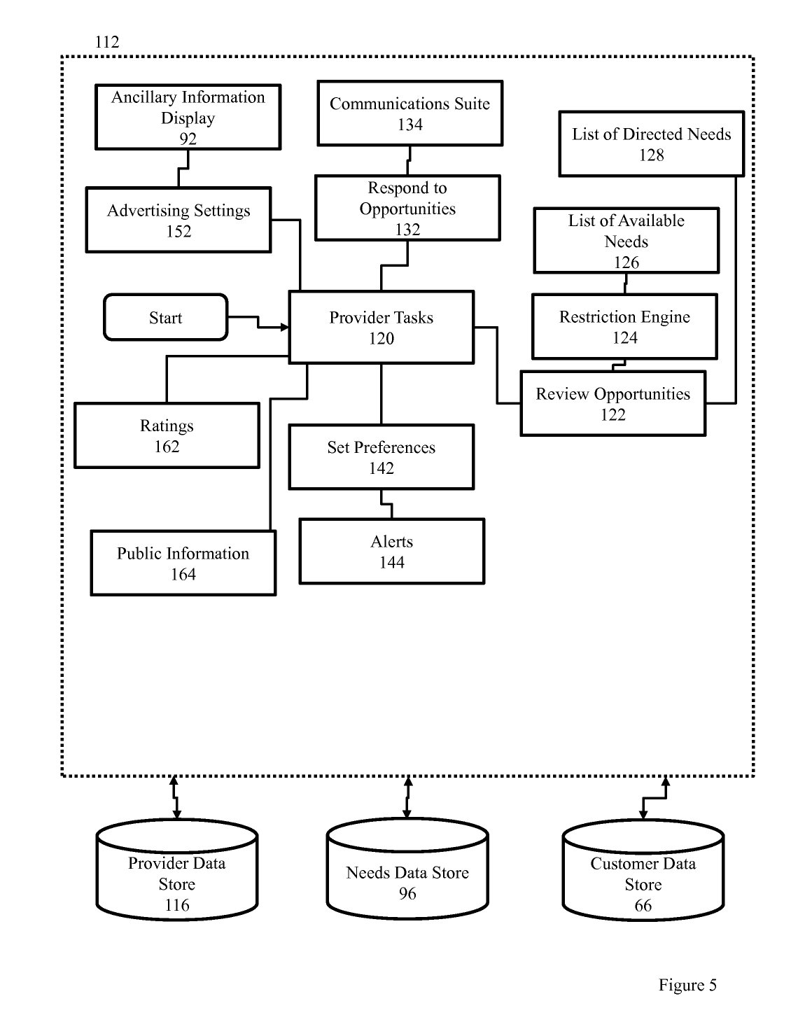

As depicted in FIG. 5, providers interact with Customer information via the Provider Access Portal 112. The Provider Data Portal allows providers to select one or more Provider Tasks 120 via a selection mechanism. In one embodiment, the selection mechanism is a web based user interface, allowing the provider to graphically select one or more tasks to be completed within the system. In another embodiment, the providers select the tasks to be completed by interacting with an interface of a stand-alone networked application. In all embodiments, the providers have a number of choices when interacting with the Provider Access Portal 112.

One task that can be selected from the Provider Tasks 120 selector is to Review Opportunities 122 available to the provider. As used herein, an “opportunity” to the provider is a “need” by a customer. Customers provide needs in the system by interacting with the Customer Information Portal 60 one embodiment of which is depicted in FIG. 3. The end product of the customer's interaction with the Customer Information Portal 60 is the population of the Needs Data Store 96 with customer needs 94 and customer instructions 98. Providers can also provide needs and instructions in the system by interacting with the Provider Information Access Portal 112. The end product of the aforementioned interaction is the population of the Needs Data Store 96.

When the provider is reviewing needs, in one embodiment two potential sources for the needs exist. First, the Restriction Engine 124 examines the Needs Data Store 96 to determine which needs in the Needs Data Store 96 are available to that provider. When posting the need in the Customer Information Portal 60, the Customer may include Instructions 98 to exclude a particular provider. As such, the provider will not see the need listed in the provider's List of Available Needs 126. Customers are not required to provide a reason why a particular provider is being excluded, and providers will have no means of knowing that they were excluded from a particular need, which will be invisible to the providers due to the restriction engine 124. In one embodiment, by default, the provider will see all non-restricted needs in the List of Available Needs 126. In another embodiment, the Restriction Engine 124 will allow the provider to apply one or more filters on the available data. For example, the provider will be able to filter the needs on the basis of the industry of the customer, the geographical location of the customer, or any other objective factors found in the needs data store 96. In one embodiment, providers of financial services, will be able to filter customers on the basis of credit score. The credit score is requested only once in a set period of time for each customer, to avoid causing a negative impact on the customer's credit score by having multiple inquiries.

In the embodiment depicted in FIG. 5, another provider task 120 is the mechanism for providers to respond to opportunities 132. That mechanism will be discussed below, in conjunction with FIG. 7, which covers the Communications Suite 134. The Communications Suite 134 is depicted as an element of the Provider Access Portal 112, but it is also accessible to the customers through the Customer Access Portal 60. The same Communications Suite 134 is used by the provider whether the need is from the List of Available Needs 126 or the opportunity is from the List of Directed Needs 128 creating a seamless interface for the provider.

Another Provider Task 120 to be performed at the Provider Access Portal 112 is the ability for the provider to Set Preferences 142. When setting preferences, the provider may change the contact information associated with the account, and may select a method of receiving Alerts 144. According to the Preference 142 set regarding the Alerts 144, a provider may receive an SMS-text message, an e-mail, or a phone call, when the List of Directed Needs 128 changes or the List of Available Needs 126 changes. The provider may set the frequency of the Alerts 144 such that only a digest of new messages arrives at a set time, rather than receiving messages every time a new entry appears on either list 126, 128. The provider is able to set these preferences 142 to allow the provider to obtain maximum benefit from the system, without causing the system to become a nuisance and a source of information overload for the provider.

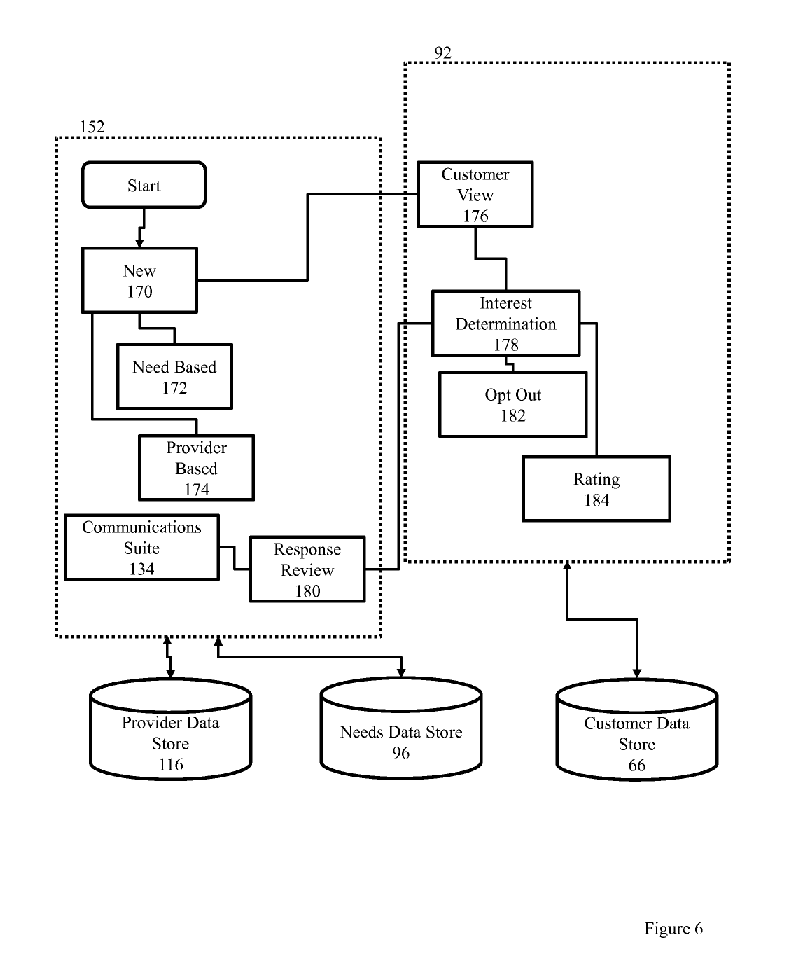

In the embodiment shown in FIG. 5, the provider may also change Advertising Settings 152 as part of the Provider Access Portal 112. The Advertising Setting Mechanism 152 controls the display of Ancillary Information 92 on the Customer Information Portal 60. The Ancillary Information Display 92 is discussed below as part of FIG. 6. The Advertising Settings 152 chosen by the provider are stored in the Provider Data Store 116.

In the embodiment shown in FIG. 5, another task performed by the provider is the creation and maintenance of a Public Information Portal 164. In one embodiment, this portal is a publicly accessible website, which is available to customers, providers registered in the system, as well as unregistered users. In one embodiment, registered users can provide comments and ratings to the content found on the Public Information Portal 164, and this feedback facility is available to non-registered visitors to the provider's Portal 164. In one embodiment as part of the Public Information Portal 164, the provider may choose to include any information or content.

However, in one embodiment, the Public Information Portal 164 cannot be amended to exclude the provider's ratings in the system. In this way, the Public Information Portal 164 allows the customers to see all information about a provider in a single page.

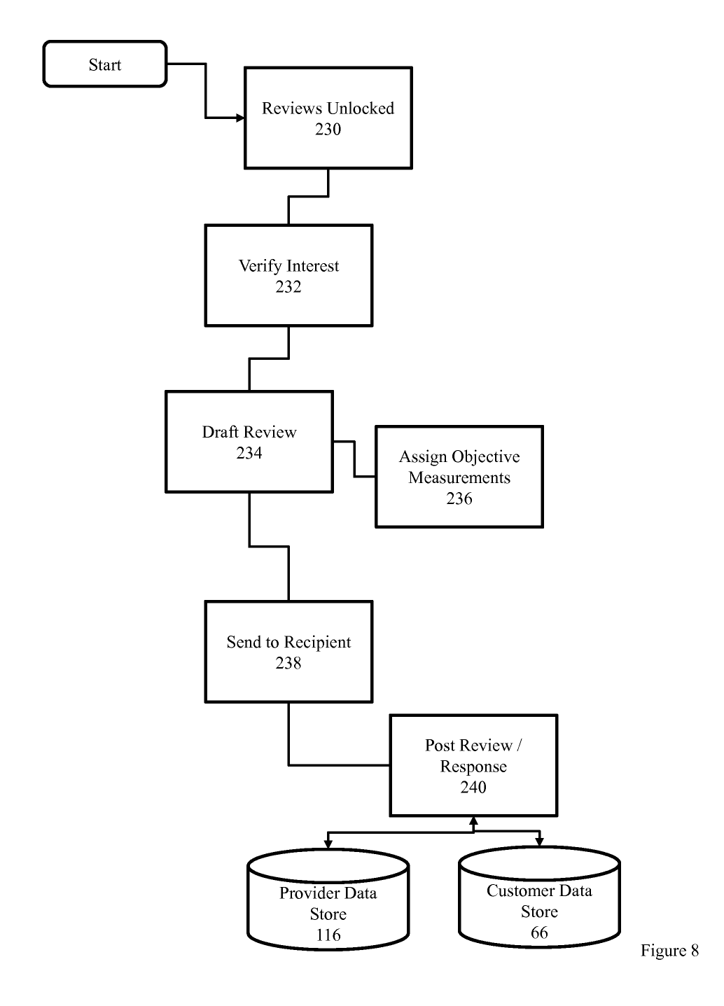

Finally, in the embodiment shown in FIG. 5, the provider may also review ratings within the system by accessing the Review Ratings Mechanism 162 discussed in conjunction with FIG. 8. The provider may review ratings of its active customers, and the ratings of any provider.

### Advertising Control

In one embodiment of the invention, the Customer Information Portal 60 includes an Ancillary Information Display 92. In the embodiment of the invention having said display, it is used to forward to customers messages from providers and to post advertising in a Customer Information Portal from providers of financial services and other third parties. The details of the Control Mechanism 152 of the Ancillary Information Display 92 are shown in FIG. 6.

The provider initiates the process by creating a New Advertisement 170. An advertisement is considered to be “New” in the system 10 if it has not previously been shown in the system 10. In one embodiment, as part of the New Advertisement 170 creation process, the provider may import into the system pre-existing Advertisements, such as from prior commercial campaigns. As part of the process of creating a New Advertisement, the provider can rely on a Pre-existing Need 172 in the database or alternatively a provider can use its own discretion to create a Provider Based 174 advertisement. A Need Based 172 advertisement would leverage a pre-existing entry for the targeted consumer or group of consumers. For instance, if a customer is seeking a financial product based on the value of a pre-existing asset, a provider of independent valuation services is able to send to that customer a Need Based 172 advertisement.

Further, in one embodiment, providers generate Provider Based 174 advertisement messages to send to customers posting needs as a type of customized “ice breaker” where the providers introduce the services of the provider and otherwise introduce themselves to the customer.

In the embodiment shown in FIG. 6, the providers must rely on the Needs Data Store 96 when creating a Need Based 172 advertisement message. Every message that is created by a provider is associated with that originator's account in the Provider Data Store 116 allowing receiving customers to rate the provider's messages as will be discussed below.

A New Message 170, in one embodiment of the invention, may comprise any reproducible multimedia message, such as a video clip, an audio recording, graphics elements, or text. In an embodiment of the invention, a New Message 170 may also comprise interactive material, such as an invitation to a video conference or a scheduled phone call with the customer. A provider is required to categorize the New Message 170 so as to allow the customer to opt out of receiving an entire class of messages.

The provider is asked to pay an origination of message fee when sending a New Message 170. This fee ensures that the provider targets the most receptive recipients and the ones most likely to benefit from the message by going through and ordering the advertised product or service. However, the origination fee is set to be attractive for providers and takes into account the customary marketing costs and customer acquisition costs for providers of financial services. Fee charged also should be high enough to prevent indiscriminate, abusive, malicious or frivolous contact requests from providers.

In one embodiment of the system, there are several types of New Messages 170 that can be created by a registered provider.

In a first type of New Message 170, advertising is placed on the Customer Information Portal 60 by a registered provider in the system. This registered provider may be any kind of a business, including a general advertiser. To determine which customers the general advertiser wishes to target, the general advertiser uses information about the customer as well as any needs posted by the customer. The resulting New Message can therefore be a Need Based 172 message or a general Provider Message 174. This type of general advertising will be designed to be timely and highly targeted and will appear on the customer's interface page.

A second type of New Message 170 is sent by providers of services and is a specific Provider Message 174 which factors not only the information about the customer (and optionally the customer's need) but also information about the provider itself. This provider-centered message will contain details including institutional information about the provider and any personalized information about the provider, such as expertise in the specific field of the posted need and in the customer's industry. For example, a personalized message could be a video delivered to a customer by a relationship banker of a global bank wanting to introduce herself as the first point of contact between the customer and the financial organization she represents . . . By incorporating information about a specific provider, the New Message 170 is intended to maximize the attractiveness and informative value of a providers' expression of interest in supplying a financial solution to a customer's need. A third type of New Message 170 comprises information produced by providers to be included in a list of providers. As part of the ancillary information display 92, customers have access to a list of providers. While in one embodiment, the list would be sortable and filterable by name, location, industry type, and size, in another embodiment, the providers are able to include a Provider List Message in this list as well. The purpose of this New Message 170 would be to introduce the customer to a field, where the customer is otherwise unfamiliar with the major providers of a given category of service.

Not all New Messages must be directed to customers. In one embodiment, a provider may also include advertising directed to other providers. Given that providers do not have needs associated with their provider account (but as was explained above providers may also have customer accounts associated therewith), New Messages to fellow providers are Provider Originated Messages 174. Further, some New Messages are directed to both providers and customers in the system and are generated not by specific providers but are rather general advertisements.

In the embodiment shown in FIG. 6, once the New Message 170 is created, the message is transmitted to be shown to the customer's Ancillary Information Display 92. For clarity, the message being sent to the customer in FIG. 6 is being depicted as being sent to only one Customer View Panel 176. However, in one embodiment of the invention, a provider may designate many simultaneous recipients of the New Message 170, regardless of whether the new Message 170 is a Need Based 172 message or a Provider Originated 174 Message. In one embodiment of the system 10, all Messages in the system are Need Based 172 Messages. In this embodiment, the number of messages in the system is lowered, therefore lowering the amount of Messages seen by customers, it is a more targeted approach but it also decreases the opportunity for customers to learn about new provider offerings.

While in FIG. 6, the message is depicted as appearing on the Ancillary Information Display 92 of the Customer Information Portal 60, in other embodiments, the Customer has control over where the Ancillary Information Display 92 appears, and whether Advertisements appear on the Customer's Information Portal. Presuming that the customer has chosen to view the Messages 170, the customer is allowed to interact with the Messages 170. The customer may, indicate the amount of interest in the message by triggering an Interest Determination mechanism 178.

The Interest Determination mechanism 178 allows the customer to indicate to the provider whether or not the received message is of interest to the customer. If the message is of interest to the customer, the provider Response Review mechanism 180 receives a positive signal and the provider is able to exchange information with the customer about need and the advertisement within the Communications Suite 134.

In the embodiment shown in FIG. 6, certain customers may also decline to receive messages by triggering an Opt Out Mechanism 182. The Opt Out Mechanism 182 is available to those customers who pay a premium access fee, or otherwise qualify for the ability to Opt Out of messages in the system, in one embodiment. Further, in one embodiment, the Opt Out Mechanism 182 allows the customer to decline further messages from the particular provider or from the class of providers. The Opt Out Mechanism 182 may also allow the customer to cease receiving similar advertisement messages, regardless of the provider. Posting of other advertisement on a Customer Information Portal cannot be blocked by customer. To help the providers improve the New Messages 170, the Customer View 176 also allows the customer to provide a Rating 184 of the New Message 170. The rating is forwarded to the provider for the provider's Response Review 180. Customers are also enabled to report any messages as abusive.

Providers sending messages reported by recipients as abusive may be permanently revoked. In one embodiment of the system, a customer will have the ability to request that a provider be banned for abusive messages, and especially messages that were given a false categorization in order to avoid an “Opt Out” filter.

The advertising feature is therefore also dependent on the Communications Suite 134 which is described below in conjunction with FIG. 7.

### Communications Suite

The system 10 is dependent on the providers and customers exchanging information and creating value through potentially leading to transactions. To facilitate this information exchange, the system 10 includes a Communications Suite 134, the details of which are shown in FIG. 7.

The Communications Suite 134 allows a provider to initiate communications with a customer to discuss a need from the Needs Data Store 96 by selecting the customer's need in the Response to Opportunities mechanism 132. At the time a provider selects a customer's need from Response to Opportunities mechanism 132, the provider is given the opportunity to purchase the customer's identity details which excludes contact information. In one embodiment of this service the provider may be able to purchase both identity and contact information. If the provider agrees to attempt to purchase the information, the process turns to the Communications Suite 134 to determine whether the customer is interested in communicating with the provider. Customers participate in the Communications Suite 134 via the Customer Communications Interface 220.

Provider-initiated communications within the Communications Suite 134 occur from within the Provider Communications Interface 200. The Provider Interface 200 allows the provider to purchase the identity of a customer, by passing to the communications suite at least one available need from the List of Available Needs 126 or the List of Directed Needs 128. If the provider wishes to buy the identity of the customer associated with the need, the system presents to the provider an Identity Selection 202 mechanism pursuant to which the provider is given the opportunity to acquire the identity of the customer. If the provider declines the purchase, the available opportunity is ignored or deleted from the provider's portal and the provider may exit the communications suite 134. However, if the provider agrees to obtain the identity of the customer, the Identity Selection 202 mechanism determines the type of fee associated with that customer or need.

Fee determination is performed by the system 10, and in one embodiment, the fee is shown by the Fee Selection 204 mechanism to the provider once the provider indicates that the provider wants to obtain the identity of the customer. In one embodiment, for every need entered in the system 10, the system 10 assigns a particular fee structure. In one embodiment, there are two different types of fees charged. For certain transactions, such as acquisition of financial products, a success fee is charged once the financial product is acquired by the customer. For other transactions, a fixed amount fee, which amount may vary according to characteristics of the underlying need, is charged to the provider. The type of fee which is shown to the provider by the fee selection 204 mechanism is determined by the purpose of the need of the customer. If the purpose is the acquisition of an ongoing service, such as payroll processing, the fee charged by the fee selection 204 mechanism is a fixed amount fee. If the purpose is an attempt to obtain a loan, which may or may not succeed, the fee charged is a success fee once the transaction occurs. In one embodiment, a combination of both fees is indicated by the fee selection 204 mechanism. The provider and the customer agree to the fee schedule in effect during the registration process 42, 110.

To continue with the process, the provider may either agree to pay the fee as indicated by the fee selection 204 mechanism. However, the provider may decline, incurring no charges, but subsequently the provider loses access to that customer's need.

If the provider chooses to pay the fee, the required amount is deducted from the provider's account and the provider obtains the legal name 206 of the customer associated with the need. Using the legal name 206 of the customer, the provider may now determine if they provider wishes to continue to contact the customer. For example, the provider may conclusively determine whether they have had previous dealings with the customer and if so, whether they wish to continue to transact with the customer. Having received the legal name of the customer, the provider may obtain third-party information about the customer, such as by getting the customer's Dun and Bradstreet report.

The provider subsequently determines whether or not to send to the customer an Expression of Interest 208 using the Communications Suite 134. If the provider does not wish to send an Expression of Interest 208, the customer's need is again removed from the provider's portal, but the fee paid by the provider to obtain the legal name of the customer is not automatically refunded.

If the provider determines that the customer should be contacted, the Provider Interest Expression 208 mechanism allows the provider to include a Need Based Message 172. In this embodiment, the Need Based Message 172 is attached to the Expression of Interest 208 Message and targets the customer by referring to the need. The Need Based Message 172 will be sent to the customer and displayed along with the output of the Provider Interest Expression 208 mechanism, and not in the Ancillary Display 92 of the Customer Information Portal 60.

The output of the Provider Interest Expression 208 mechanism is transmitted to the Customer Interface 210. From the Customer Interface 210, the target customer may choose to respond to the Provider Interest Expression 208. In one embodiment, in order to respond, the customer selects that the customer is “also interested” in the Provider Interest Expression 208. In one embodiment, the customer may, in response to any Expression of Interest 208, accept, delete, ignore, or ban the Expression of Interest 208. If the customer does nothing, the Customer Interface 210 will expire the Expression of Interest 208 treating the Expression of Interest 208 as ignored following a set amount of time. In one embodiment, the provider may indicate an expiration date for the Interest Expression 208.

Inasmuch as the provider's offers are time sensitive, the Customer Interface 210 will attempt to remind the customer about any pending Expressions of Interest 208 within the system, by for example sending the customer an e-mail alert, a text message, a phone call, or even sending the customer a pre-printed postcard reminding the customer about the pending offer.

Upon receipt of the Provider Expression of Interest 208, the customer may invoke the Customer Rating 220 mechanism to send the provider a rating of the Expression of Interest. The Rating 220 mechanism is described in conjunction with FIG. 8 below. Through this mechanism a customer is also able to Rate and Review the service received from the provider of financial services.

If the potential customer accepts the Expression of Interest 208, the customer may prepare its own message 212 of acceptance to the provider. The Customer Acceptance Message 212 creation mechanism will allow the customer to respond to any initial inquiries included by the provider in the Expression of Interest 208. In one embodiment, the customer may accept the Expression of Interest by simply agreeing to the Expression of Interest 208. When the customer accepts 212 the Expression of Interest 208, a message is sent to the provider. The provider receives the customer's contact information 214.

Following customer acceptance 212, the provider and the customer are able to discuss, negotiate and complete the transaction. In one embodiment, the transaction conclusion 216 mechanism is external to the system 10. In this embodiment to the system, once the customer's contact information 214 is sent to the provider, the provider and the customer interact outside of the system 10 to conclude the transaction 216. However, given that for some transactions the fee selection 204 mechanism requires the provider to pay a “success fee,” the transaction conclusion 216 mechanism within the communications suite 134 is designed to remind the provider that a “success fee” will be incurred in conjunction with the transaction at the conclusion of the transaction. Further, the transaction conclusion 216 mechanism is designed to allow the customers to provide ratings about the conduct of the provider during the transaction process. For purposes of the rating mechanism described below, the transaction is considered to be open while the transaction is in the conclusion stage 216.

In one embodiment of the communications suite 134, a need based message 172 can be sent to the customer independently of the provider expression of interest 208. Such an Independent Message 218 is sent to the customer separately from the Expression of Interest 208. An Independent Message 218 is sent to a customer when the originating provider does not wish to fulfill the specific need of the customer, but wants to offer a product or service either related to the need, or of value to similarly positioned customers. In some respects, the Independent Message 218 is no longer a Need Based Message 172, but it is sent only after the provider has selected to view the identity of the customer 202. Upon receiving the Independent Message 208, to the Customer's Interface 210, the customer may respond to the Message 208 using the Customer Acceptance 212 mechanism. The provider's sending of an Independent Message 218 also allows the customer to post a Rating 220 about the provider and the provider's messages.

The communications suite 134, in this embodiment, allows providers and customers to exchange information securely with one another, while preserving the customer's privacy in that the customer's name is not visible to everyone, but only those providers that are interested in meeting the customer's need and paying the fee. Before the customer's full contact information 214 is revealed to an interested provider, the customer must agree to divulge the information. Finally, fees are charged both to ensure that the participants in the system are there for a good faith reason, but also to support the system's operation.

Provider reviews and ratings are stored in the Provider Data Store 116. Other information stored in the Provider Data Store 116 include fees charged to providers and the advertisements sent by providers. Contact information about customers is retrieved from the Customer Data Store 66.

### Review Details

As depicted in several places in the figures, the system 10 includes several opportunities for system 10 participants to review performance of both providers and customers. The details of the review process are found in FIG. 8.

The process begins with unlocking 230 of the review ability in either the Customer Data Portal 60, the Provider Access Portal 112, or the Communications Suite 134. Given that the review system is not open by default, customers and providers may only review each other if the two are engaged in a transaction (as defined in the active interest 232 discussion), or as part of receiving a New Advertisement 170 from a provider.

Once the review process is unlocked 230, the system verifies that the parties have an active interest 232 in reviewing one another. For example, if either the provider or the customer has quit the system since initiating a transaction, there is no more an active interest in pursuing the review 232. By limiting the reviews to active transactions, the system ensures that the parties have the impetus to provide detailed and well thought-out reviews, as opposed to simple one-line complaints or complements. In fact, the system could incentivize customers to provide reviews, by offering promotions for providing reviews whenever an active interest exists between the customer and the provider.

Once a valid and active interest between the customer and provider is verified 232, the author of the review is asked to draft a review narrative 234. Depending on the type of review recipient, the review author may be asked to assign objective quality measurements or Ratings 236 to grade the exchange between the review author and recipient.

Once the narrative 234 and objective measurements 236 are assigned, the case moves to be reviewed by the recipient 238 of the review. For example, providers as part of the Provider Access Portal 112 have as one of the available tasks, a mechanism to respond to Ratings 162. While the recipient receives the narrative 234 and the objective measurements 236, the recipient cannot override either information. Instead, the recipient may only respond with its own narrative. After a set amount of time, the Review, the Rating and any Response may be posted to the system 10. Reviews, Ratings and Responses may be accessible to the system 10 by being recorded in the Customer and Provider Data Stores 66, 116.

Customers may view Ratings, Reviews and Responses associated with any Provider. Providers may see Ratings, Reviews and Responses associated with a customer only once the Provider has purchased a customer's identifying information.

### Fees Charged

Part of the benefits of the system is the accessibility of the system to initial registration, and the ability of the system to become self-sustainable through the collection of fees and advertising revenue. Registration with the system 10 is free to both customers and providers. However, to receive legal name identification about a customer, the provider must pay a fee. Further, the provider is expected to pay a fee in some cases should a transaction be successful. Finally, providers pay for messages sent to customers and to other providers.

By charging fees, the system seeks to ensure that only good-faith providers participate in the system, and the payment of fees facilitates the verification steps when new customers and providers seek to be registered to the system. Fees charged also remain attractive to providers in view of customary customer acquisition costs for providers of financial services. In one embodiment, registration fees may be charged. In such an embodiment, the registration fees may vary depending on objective factors to protect the relevance and the value of the service.

### Example of Use of System

Company A is located in Seattle, Wash. Company A is a producer of specialty chemicals. It was established 26 years ago and currently has 115 employees. With a chemical engineering background, Patrick D. has been with the company 15 years and is the financial and administrative manager. Taking care of business development, human resources, accounting, payroll, accounts payable, taxes and treasury, Patrick D. is concerned that he never seems to have enough time to explore how to reduce the cost of debt of Company A. The business is going well but the competition is tough and the company cannot increase prices to expand profit margins. Rather, Company A has been devoted to research and innovation always pursuing to improve production processes to reduce costs and in order to differentiate itself from competitors.

Patrick D. feels that there is an opportunity to further contribute to cost reduction efforts by reducing the company's cost of debt, however in addition of being extremely busy, he simply doesn't know where to start a market discovery process in the search for cheaper and more convenient sources of financing. A few days ago in a chemicals conference, a competitor, Mr. Gordon, mentioned to Patrick D. how Company B, a company very similar to Company A, effortlessly refinanced its debt after using a free online service. Mr. Gordon explained how the visibility gained by Company B ultimately lead to a successful refinancing within just a few days. Patrick D. decided to explore this online service by registering and posting Company's A interest in refinancing $3 million in debt outstanding. To avoid disturbing those relationships, Patrick D. instructed the online service not to let the three banks Company A had traditionally worked with to know about his interest in refinancing. Patrick D. also made sure to instruct the online service his preference to engage financial service providers with a background in the chemicals industry. These “need” and “instructions” are posted to the service. Patrick D. knows that a point in the process any financial service providers interested in this opportunity will have access to Company A's name but that also it is up to him to choose which providers will obtain his contact information. This feature protects Patrick D. from being “spammed” with calls, emails or letters from providers he is not interested in engaging.

After posting the need and instructions in the system, Patrick D. comes back from lunch to find out that seven financial providers want to talk to him about Company's A interest in refinancing. Of the seven entities, three are large banks Patrick which names Patrick can recognize. Four names are completely unknown to him but he is not surprised about that fact after remembering that, according to the Federal Deposit Insurance Corporation, at the end of June 2011 there were more than 7,500 FDIC-Insured Institutions in the United States. Each of the messages expressing interest from these four banks came accompanied by accessible multimedia messages he reviews. All the messages were short but very insightful. The most impressive message, Patrick thought came from a bank in Indianapolis called Growth Bank. The message from Growth Bank was a personal video clip where the bank's CEO, Mr. Thompson, specifically addressed Company A and how Growth Bank's experience in the chemicals industry, in addition to the bank's strength and commitment to service could be valuable assets to Company A. The message also included key facts about that bank and how to work together. Of the seven messages Patrick decides to click in the screen menu provided by the service “Also Interested” in four out of the seven messages. He knows that by selecting this option his contact information will be disclosed to these four banks.

Patrick also sends a personalized note to each one of these banks through the online service indicating why he decided to contact them and providing some more details about Company A's need. To the other banks Patrick decides to answer form a selection menu “Another Time, Thanks”. Within two days Patrick has been able to arrange video calls outside the online service and to have personal meetings with all four banks he selected. In a matter of weeks Company A had four proposals to refinance its debt and one of these proposals, which resulted in substantial savings and enhanced flexibility for the company, had been chosen. The winning proposal came from Growth Bank in Indianapolis, an excellent financial services institution but without the marketing budget for advertising campaigns in distant regions where the bank is authorized to operate.

The online service used by Patrick D. has become a tremendous asset for Growth Bank's expansion strategy in identifying new business opportunities and in delivering highly targeted, relevant and timely messages to potential customers associated with those business opportunities. Mr. Thompson, Growth Bank's CEO, believes that commitment to excellent service and responsible financial and risk management are powerful differentiating factors which in time should position Growth Bank ahead of the competition. That strategy is working. A source of new customers has been the Ratings and Reviews written about Growth Bank by happy customers on the online service which introduced Growth Bank to Company A. One of those high ratings and positive reviews was recently posted by Patrick D from Company A, who now has the peace of mind gained by having discovered and arranged better financial terms for his company and which allows him to focus on other key competitive priorities for Company A pertaining to its core activities. Mr. Thompson from Grow Bank feels that to a large extent thanks to this online service he and his team can truly focus on long term priorities and on investing scarce resources in sustainable growth and in complying with a much more demanding banking regulatory environment as it is the case under Basel 2, Basel 3, and Dodd-Frank.

It is to be understood that the above description is intended to be illustrative, and not restrictive. The embodiment of this invention refers to the financial services industry but other embodiments of the invention pertain to other industries where the business method of the invention can be applied. Also, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

The embodiment of the invention in which an exclusive property or privilege is claimed is defined as follows:

1. An information service for customers comprising:
a) a system presenting an opportunity for customers to save resources in selecting a provider to fulfill a customer need, said system having a means for customers to provide to the system information about said customers, said information comprising a need and instructions; wherein said need is posted to the system without all information about the posting customer visible within the system;
b) a means for registered providers to save resources in identifying business opportunities in viewing said needs;
c) a means for providers to select a need in the system and to pay for identification information about the customer who posted a selected need; and
d) a means for the providers to transmit to customers one or more messages regarding services of the providers; wherein the providers pay a fee for sending said messages;
e) a means for the customers to protect their privacy and selectively engage the providers when the providers select a customer's need and attempts to contact the customer;
wherein said system allows the customers to increase market visibility of their needs and wherein said system is conducive to allow the customers to obtain the lowest costs and best terms available to meet said needs; wherein service enables the providers to compete and also to differentiate themselves through ratings and reviews.

2. The information service of claim 1 further comprising a means for the providers and the customers to issue ratings and reviews to the remaining participants in the system.

3. The information service of claim 1 wherein each provider is charged a fee for viewing the legal name of a customer associated with a need and further viewing other identifying information about a customer associated with a need.

4. The information service of claim 1 wherein said customers are not matched to said providers and wherein providers select needs and customers, and customers selectively engage providers.

5. The information service of claim 1 further comprising a provider sending at least one customer a message relating to a need entered in the system wherein said provider is charged a fee for sending said message.

6. The information service of claim 1 further comprising a means for a customer to post its needs and setting instructions, a means for screening and contacting providers, a means to rate and review providers, and a means for viewing messages from providers and receiving advertisement from providers, general advertisers, and third parties.

7. The information service of claim 1 further comprising a means for providers to review needs from customers; a mechanism to respond to customer needs; a means to pay fees; a means for sending advertisements; a means to provide ratings and reviews; a means to post needs and set instructions; a means to receive advertisement, a means to manage a publicly accessible provider portal, and a means to set provider preferences.

8. The information service of claim 6 further comprising charging a provider a fee for revealing a complete legal name of a customer; wherein the customer may chose to initially engage, continue to engage or discontinue engaging with the provider.

9. The information service of claim 8 further comprising a means for the customer to block disclosure of customer identity if the provider initially inquires as to the customer identity, the customer sees this initial inquiry, and choses to not initially engage with the provider.

10. The information service of claim 8 wherein multiple providers are allowed to purchase the complete legal name associated with a same single customer need and a single customer.

11. The information service of claim 8 wherein the popularity of servicing the customer need is provided to the customer and the provider.

12. The information service of claim 1 wherein the means for customers to register the service need comprises a customer website, and wherein customers may permanently discontinue communications with any provider once the communications has begun.

13. An information service comprising:
a) a customer registration means for customers to register with the service and prescreening information provided by the customers;
b) a service provider registration means for financial service providers to register with the service and prescreening information provided by the providers;
c) a customer posting means for at least one registered customer to post information about a financial need of said registered customer, said financial need including one or more objective criterion, and the need including one or more instructions;
d) a provider registration and review means for at least one registered provider to review all qualifying financial needs posted in the system filtering the needs on the basis of objective criterion included in each of the qualifying posted financial needs;
e) a market intelligence means where a provider can review and be informed about financial needs and can purchase customer identifying information associated with certain financial needs;
f) communication and advertising means wherein an interested provider selects at least one identified customer associated with the posted financial need to initiate discussion of financial need and can opt to deliver marketing information and contact information of the selected customer is disclosed to the interested provider only at the discretion of customer wherein said one or more instructions associated with a need may indicate that a customer prevents one or more providers from reviewing the customer's need.

14. The information service of claim 13 wherein said registration means comprises a web-based portal.

15. The information service of claim 13 wherein said communication means comprises a provider portal and a customer portal, wherein a provider posts information to the provider portal and the customer posts and responds to providers on the customer portal.

16. The information service of claim 13 wherein the provider may review all financial needs posted on the website regardless of the objective criterion included in each posted financial need so long as the provider has not been excluded from viewing by the customer who posted the financial need and the instructions associated with the need.

17. The information service of claim 13 wherein the customer posting of need comprises a general announcement of a financial need.

18. The information service of claim 13 wherein the contact by the interested provider may include information about the interested provider designed to introduce the interested provider to the selected customer.

19. The information service of claim 13 wherein a provider pays an initial contact fee to obtain a name of the customer associated with a selected financial need.

20. The information service of claim 19 wherein the customer gives permission to the release of customer's full information prior to sending same to the provider.
